(19) United States
(12) Patent Application Publication
(10) Pub. No.: US 2006/0280209 A1
(43) Pub. Date: Dec. 14, 2006

(54) Beam combining methods and devices with high output intensity

(76) Inventors: Hans-Georg Treusch, Tucson, AZ (US); Christophe Moser, Pasadena, CA (US); James Harrison, Oro Valley, AZ (US); Gregory J. Steckman, Glendora, CA (US)

Correspondence Address: BIOTECHNOLOGY LAW GROUP;C/O PORTFOLIOIP, PO BOX 52050, MINNEAPOLIS, MN, 55402, US

(21) Appl. No.: 11/352,500

(22) Filed: Feb. 10, 2006

Related U.S. Application Data
(60) Provisional application No. 60/652,088, filed on Feb. 11, 2005.

(51) Int. Cl. H01S 3/13

(52) U.S. Cl. 372/32

(57) ABSTRACT

Embodiments are directed to a beam combining apparatus including a light source having a first emitter with a first output wavelength and at least one second emitter having a second output wavelength. A beam conditioning section is configured to collimate the output of the emitters and provide diffractive optical feedback to the emitters and a diffractive beam combining device is configured to spatially overlap the output wavelengths of the first emitter and at least one second emitter.

### CROSS REFERENCE TO RELATED APPLICATIONS

This application claims priority under 35 U.S.C. section 119(e) from U.S. Provisional Patent application Ser. No. 60/652,088 titled “High Spectral Brightness Coupled Laser Diode Stack”, filed Feb. 11, 2005, by Treusch, H. et al. which is also incorporated by reference herein in its entirety.

### BACKGROUND

There is an ongoing need for high output power solid state laser systems that may be used for a variety of applications. One technique for producing such a high-power output system is to combine the output beams of a plurality of solid state emitters, such as laser diodes. Some applications, such as the pumping of laser gain material, often require an output beam with high power and with a narrow spectral bandwidth. Such a system may require wavelength locking of the output of all emitters in the system, as there are typically variations in output beam characteristics with respect to individual emitters in an array, even within the same laser diode bar. The process of combining the output beams of such a system may require cumbersome optic elements. However, some applications for high power solid state laser output do not require such a narrow spectral bandwidth. Thermal or material processing applications such as welding, brazing, soldering, hole drilling, curing of curable materials, heat treating and the like require an output beam having a sufficiently high intensity to melt or remove material of a substrate or the like but do not necessarily require a narrow spectral bandwidth. While existing solid state laser systems may be used to produce a high intensity output for such uses, these systems may be large and cumbersome due to the use of standard optics for combining the output of a plurality of solid state emitters, or may be expensive to produce due to the use of more expensive micro-optics which may be more costly to manufacture and align in a solid state laser system.

What has been needed are compact and cost effective beam combining methods and devices that reliably produce an output beam having sufficiently high intensity or power to be useful for thermal applications, material processing applications or the like.

### SUMMARY

Some embodiments of a beam combining apparatus include a light source having a first emitter with a first output wavelength and at least one second emitter with a second output wavelength. A beam conditioning section is disposed in optical communication with the light source, configured to collimate the output of the emitters and provide diffractive optical feedback to the emitters. A diffractive beam combining device is configured to spatially overlap the output wavelengths of the first emitter and at least one second emitter.

Some embodiments of a beam combining apparatus include a light source having a first laser diode bar including a plurality of laser diode emitters having a first output wavelength and at least one additional laser diode bar including a plurality of laser diode emitters having a second output wavelength. A beam conditioning section disposed in optical communication with the light source includes a fast axis collimator and a slow axis collimator configured to collimate the output of the laser diode bars and a volume holographic grating (VHG) configured to provide optical feedback at the first output wavelength to the first laser diode bar and provide optical feedback at the second wavelength to the additional laser diode bar. A beam combining VHG is disposed in optical communication with the beam conditioning section and is configured to diffract an output beam of the first laser diode bar to an output optical axis and diffract an output beam of the additional laser diode bar to the output optical axis so as to spatially overlap the output beams of the first laser diode bar and additional laser diode bar.

Some embodiments of a method of producing an optical beam include emitting a first output beam from a first wavelength locked emitter, emitting a second output beam from a second wavelength locked emitter. The first and second output beams are then diffracted with a diffractive optical element to an output optical axis in which the first output beam and second output beam are spatially overlapped.

These features of embodiments will become more apparent from the following detailed description when taken in conjunction with the accompanying exemplary drawings.

### BRIEF DESCRIPTION OF THE DRAWINGS

FIG. 1 shows a schematic diagram of an embodiment of a beam combining apparatus having a light source with multiple emitters in a linear array.

FIG. 2 shows a detail of a beam combining element of the beam combining device of the beam combining apparatus shown in FIG. 1, with a reference coordinate system.

FIG.3 shows a schematic of an embodiment of a beam combining apparatus having a light source with three linear arrays of emitters in the form of diode laser bars.

### DETAILED DESCRIPTION

Semiconductor diode lasers consisting of monolithic arrays of multiple emitters are commonly referred to as diode laser bars. Combining the output beams of the individual emitters of a single laser diode bar or combining the output beams of individual emitters of multiple or stacked laser diode bars is a means for producing a high power output from a compact and cost effective source. However, combining the output beams from such a multiple emitter light source may prove difficult.

Some applications for solid state laser output require a narrow spectral bandwidth. As discussed above, pumping a laser gain material may be such an application. Generally, achieving exactly the same wavelength or otherwise narrow overall bandwidth of all emitters of a laser diode bar is often difficult due to variations in diode bar processing. For example, some embodiments of laser diode bars may include about 10 to about 65 individual emitters therein and may emit light having a centroid or peak wavelength of about 300 nm to about 2000 nm, more specifically, of about 600 nm to about 1000 nm, including wavelengths across the near infrared spectrum. Some particular embodiments of useful emitters may emit light at a peak wavelength of about 350 nm to about 550 nm, 600 nm to about 1350 nm or about 1450 nm to about 2000 nm. Such laser diode bars may be operated in either a pulsed mode or continuous wave mode.

Frequently, the output spectral band of unlocked individual emitters of a laser diode bar, or other suitable group of emitters, may be about 0.5 nm to about 2.0 nm or more. Due to the variation in peak emission wavelength in addition to the spectral band for each individual emitter, the overall bandwidth of the laser diode bar may be about 2 nm to about 5 nm, for some embodiments. Controlling the wavelength of the output beams of the emitters of an individual laser diode bar through optical feedback offers a means of producing output beams from individual emitters of a laser diode bar or other multiple emitter light source at the same or similar wavelength resulting in increased “spectral brightness”, at narrower spectral bandwidth.

Optical feedback may be provided with a partial reflector, such as a partially reflective mirror or the like. Optical feedback may also be provided by a diffractive optic such as a VHG otherwise known as a volume Bragg grating (VBG). Diffractive optics such as a VHG may be configured to provide optical feedback in the form of partial reflection. The term reflection or partial reflection for the purposes of the discussion herein is meant to encompass any process by which light is directed generally back towards the direction of incidence of the light by a surface or volume of material. Examples of such reflection or partial reflection may include Fresnel reflection and diffraction. However, diffractive optics may also serve to narrow the bandwidth of reflected light to a pre-selected wavelength. Specifically, a VHG may be configured to provide diffractive feedback from an incident beam in the opposite direction of the incident beam and within a narrow pre-selected spectral band, the bandwidth of which is at least partially determined by the characteristics of the diffractive optical element. Diffractive feedback for some embodiments of VHGs may be configured to be about 5 percent to about 40 percent of the power of an incident beam having a substantially narrow bandwidth at the peak diffraction wavelength of the VHG. For some embodiments, the peak diffraction wavelength of a reflective VBG may be between about 300 nm to about 2000 nm.

Such diffractive optical feedback may be used to wavelength lock or substantially wavelength lock the output beams of the individual emitters of a laser diode bar or bars. The spectral width of the combined beam may then be compatible with the requirements of wavelength-sensitive applications, such as solid state laser material pumping. The individual emitters of a particular laser diode bar may be wavelength locked at substantially the same wavelength, or may be wavelength locked at different pre-selected wavelengths based on the configuration of the VHG. Wavelength locking at different wavelengths may be useful for combining the output beams of the emitters by a diffractive optic as will be discussed in more detail below. An emitter of a laser diode bar with optical feedback may have an output beam with a peak wavelength positioned to a tolerance of less than about 1 nm and with a spectral width of less than about 1 nm.

In some embodiments, the spectral width of an individual emitter of a laser diode or laser diode bar may be about 0.2 nm to about 2.0 nm. For a laser diode bar have about 10 individual emitters to about 65 individual emitters, the overall spectral width of the output beams of the laser diode bar may be about 0.5 nm to about 5 nm. The spectral width of an output beam of an individual wavelength locked emitter of a laser diode bar may be about 0.05 nm to about 1.0 nm. An output beam of all emitters of a laser diode bar with wavelength locking at a single peak wavelength may have an overall spectral bandwidth which is substantially equivalent to that of a single wavelength locked emitter, or about 0.05 nm to about 1.0 nm. These output beams may then be combined to produce a high power beam with a high spectral brightness. However, the wavelength locking of emitters of a multi-emitter laser diode bar may be configured to deliberately vary the peak wavelength of each individual emitter or group of adjacent emitters, so as to minimize or eliminate significant spectral overlap between adjacent emitters or groups of adjacent emitters. For an embodiment of a laser diode bar having about 10 individual emitters, with each emitter having a spectral bandwidth of about 0.2 nm, the overall spectral bandwidth of the output of the laser diode bar will be at least about 2 nm if the peak wavelength of each emitter is deliberately varied to avoid or minimize significant spectral overlap with the output of adjacent emitters.

Diffractive optics such as a VHG typically include a volume of material having a periodic perturbation of refractive index that may be configured to have a peak diffraction wavelength that is substantially uniform throughout the volume of the VHG or a section thereof. A VHG may also be “chirped” or graded so as to have a period, depth or contrast that varies from one portion to another so as to vary the peak diffraction wavelength from one portion to another. A VHG which is chirped so as to have a Bragg phase matching condition or peak diffraction wavelength for a first wavelength at one end and a different peak diffraction wavelength at a second end opposite the first end is an embodiment that may be useful. Such a variation of the periodic perturbation of the refractive index may be continuously varied (or chirped) across a monolithic VHG or a portion thereof. However, a VHG may also be broken down into separate components or sections with each section have a uniform spatial distribution of a diffractive spectral response or response function which is different from response function of adjacent sections of the VHG. A section or component of a VHG may also have a non-uniform or varied response function. Both the thickness and depth or strength in the form of contrast may affect the response function of the VHG and may be used to configure a VHG to provide a desired function.

Using a combination of diffractive optical feedback methods and diffractive beam combining optics may enable the combination of output beams from single laser diode bars or multiple laser diode bars arranged in stacks or any other suitable configuration. In some embodiments, the individual emitters of a laser diode bar may all be wavelength locked at a single wavelength which may be slightly different than the wavelength of the output beams of the individual emitters of an adjacent laser diode bar of a stack. The output beams of each laser diode bar may then be combined by a diffractive optic, such as a VHG that is configured to spatially overlap the output beams of each laser diode bar. In other embodiments, the individual emitters or groups of adjacent emitters may be wavelength locked at different or slightly different wavelengths. This also may be done in order to facilitate combination of the output beams 34 from the laser diode bar with a diffractive optic or VHG.

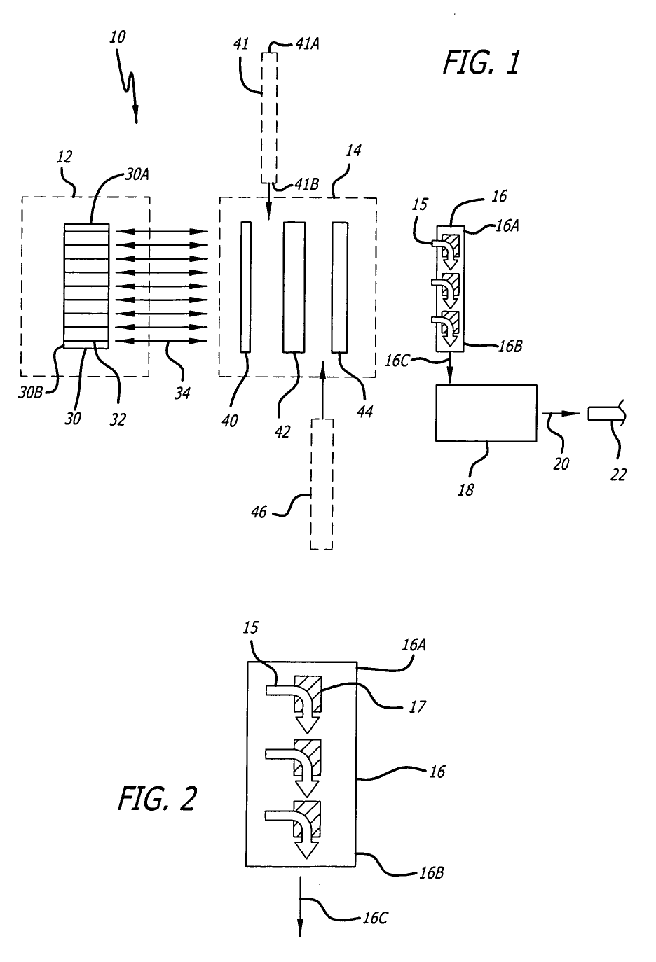

FIG. 1 shows an embodiment of a beam combining apparatus 10. Beam combining apparatus 10 includes a light emitting section 12 having a light source 30 in the form of a laser diode bar having a plurality of emitters 32 emitting beams 34. Although a laser diode bar is illustrated, other forms of emitter arrays, linear or otherwise, may be used which have like fast axis and slow axis orientation. Light source 30 includes a plurality of emitters 32, which may include about 10 emitters 32 to about 65 emitters 32 for some embodiments, other embodiments may include one or more emitters 32. In the illustrated embodiment, a beam conditioning section 14 includes a fast axis collimator (FAC) 40, beam shaping optic 42 and slow axis collimator (SAC) 44 in optical communication with light emitting section 12. Beams 15 from beam conditioning section 14 enter beam combining device 16, which is in optical communication with beam conditioning section 14 and beams 15 are directed towards beam shaping optic 18 and thereafter coupled into optical device 22. Optical device 22 may be any suitable optical device that is configured to receive light such as waveguide devices, laser rods, gas cells, multiplexers, polarizers or the like. Exemplary waveguide devices may include an optical fiber or fibers, as well as hollow waveguides and the like.

Beam conditioning section 14 includes a reflective optic 41 in optical communication with light emitting section 12. Reflective optic 41 may reflect some percentage of one or more beams 34. In an embodiment where light source 30 has one or more laser emitters 32, such feedback may result in locking the wavelength of one or more emitters 32 at a wavelength that is desired for certain wavelength-sensitive applications, such as the pumping of solid state laser materials. For efficient spectral combining of the beams 15, each emitter is wavelength-locked to a slightly different peak wavelength by the reflective optic 41. Although there may be some spectral overlap of adjacent emitters 32 or groups of adjacent emitters 32 for such embodiments, spectral overlap may lead to inefficiencies in subsequent beam combining processes. As such, it may be useful to avoid spectral overlap of the output beams of adjacent emitters 32 for embodiments of the system that incorporate spectral combination of beams 34.

In some embodiments, reflective optic 41 may include a volume holographic grating or VHG which is chirped so as to vary the peak diffraction wavelength of the VHG vertically from a top end 41A to a bottom end 41B. In this way, beams 34 emitted from a top portion 30A of the laser diode bar 30 will be wavelength locked at a different wavelength than the beams 34 emitted from a bottom portion 30B of the laser diode bar 30. The spatial distribution of the diffractive spectral response or “response function” may be configured to coincide with a response function of the beam combining device or VHG 16. The response function of VHG 41 and VHG 16 may be configured such that beam 15 entering the top portion 16A of the beam combining device 16 will be at a wavelength that is different from the peak diffraction wavelength of a bottom portion 16B of the beam combining device 16. This allows the beam combining element 17 to diffract and bend or otherwise redirect beam 15 at a top portion 16A of the beam combining device 16 while allowing diffracted beam 15 emitted from combining element 17 to pass through a middle and bottom portion 16B of the beam combining device 16 along an output axis 16C without significant further diffraction of diffracted beam 15. The VHG 41 and beam combining device 16 may be configured such that all beams 34 may be diffracted and spatially overlapped along the output axis 16C within the beam combining device 16 without substantial further diffraction of the diffracted or redirected beams after being initially redirected.

If reflective optic 41 is in the form of a diffractive optic, such as a VHG, the acceptance parameters of the VHG may require that the beams 34 be substantially collimated, at least as to the fast axis. As such, it may be useful to have the FAC disposed between the reflective optic 41 and the light source 30. If beam conditioning section 14 does not include beam shaping optic 42, the divergence of the slow axis of beams 34 may prevent efficient beam combining due to limitations in the in-plane angular selectivity of beam combining device 16. With beam conditioning section 14 in place, the collimated beam 34 from a fast axis enters the beam combining device 16. The divergence of the fast axis of the beams 34 may be reduced for efficient combining. The out-of-plane angular selectivity of the beam combining device 16 is less than the in-plane angular selectivity of the beam combining device 16. A smaller divergence angle for beams 34 may be achieved by increasing the beam size of beams 34 emitted immediately from the emitters 32. Increasing the slow axis beam size may result in less slow axis divergence and spectral combination of the beams 34 by embodiments of the beam combining device 16 which are configured to spectrally combine beams 34.

For some embodiments, beams 34 emerging from light emitting section 12 have a fast axis aperture of about 1 μm with a divergence of about 500 mrad, and a slow axis aperture of about 150 μm with a divergence of about 120 mrad. In this embodiment, beams 34 emerge from optical system 14 with a beam size in the fast axis of about 450 μm and a divergence of about 1.5 mrad and a beam size in the slow axis of about 900 μm and a beam divergence of about 40 mrad. In other embodiments, beams 34 may have a fast axis aperture of less than 1 μm with a divergence of greater than 500 mrad, and a slow axis aperture of less than 150 μm with a divergence of greater than 120 mrad. In still other embodiments, beams 34 may have a fast axis aperture of greater than 1 μm with a divergence of less than 500 mrad, and a slow axis aperture of greater than 150 μm with a divergence of less than 120 mrad.

Beam conditioning section 14 may include a beam rotating element, which may be in the form of the additional optical element 46, so that the beam axis with the larger divergence is out-of-plane with respect to beam combining device 16, and the axis with the smaller divergence is in-plane with respect to beam combining device 16. Optionally, the beam conditioning section 14 may include any number of lenses, polarizers, spatial modulators, filters, gratings, or holographic optical elements, and the like in order to expand or contract beams 34 as well as providing for a desired beam distribution which may include a substantially uniform power distribution through the beam conditioning section 14. For example, additional optical element 46 may be placed into beam conditioning section 14 in optical communication with one or more beams 34. For some embodiments, additional optical element 46 may be fixed in place in beam combining section 14. In other embodiments, optical element 46 may be removably placed in beam conditioning section 14.

FIG. 2 shows a detail of beam combining device 16 with a reference coordinate system. Beam 15 enters at least one beam combining element 17 of the beam combining device 16 and exits beam combining element 17. The reference coordinate system of FIG. 2 defines in-plane as XY, and out-of-plane as XZ. Beam combining device 16 accepts one or more beams 34 which have passed through the beam conditioning section 14, which may be disposed at different locations in space. The optical properties of beam combining device 16 are configured to direct the one or more beams 34 into a smaller volume or otherwise combine the beams so as to be spatially overlapped within the beam combining device 16. The response function, which may take the form of chirping, or other spatial function of period, depth or contrast of a diffractive optic or VHG of the beam combining device 16 may be mapped or otherwise correspond to the response function of a diffractive reflective optic 41. This mapping may be configured such that a light ray or beam 34 exiting the reflective optic 41 will have a peak wavelength that matches the peak diffractive wavelength of a portion of the beam combining device 16 which is in the optical path of the same light ray or beam 34. Note also, that although the response functions of the reflective optic 41 and beam combining device 16 may correspond, the beam combining device may be configured to have a pre-selected slant that redirects incoming beams 15 to a path along or parallel to output axis 16C of the beam combining device 16.

For some embodiments, beam combining device 16 may have an interaction length of about 0.1 mm to about 10 mm, a wavelength sensitivity at full-width half-maximum (FWHM) of about 0.2 nm to about 15 nm and an acceptance angle sensitivity of about 1 mrad to about 5 mrad in plane and about 25 mrad to about 500 mrad out-of-plane. For other embodiments, the beam combining device may have an interaction length of about 0.5 mm, a wavelength sensitivity FWHM of about 1 nm, angle sensitivity of about 2 mrad in-plane and about 75 mrad out-of-plane.

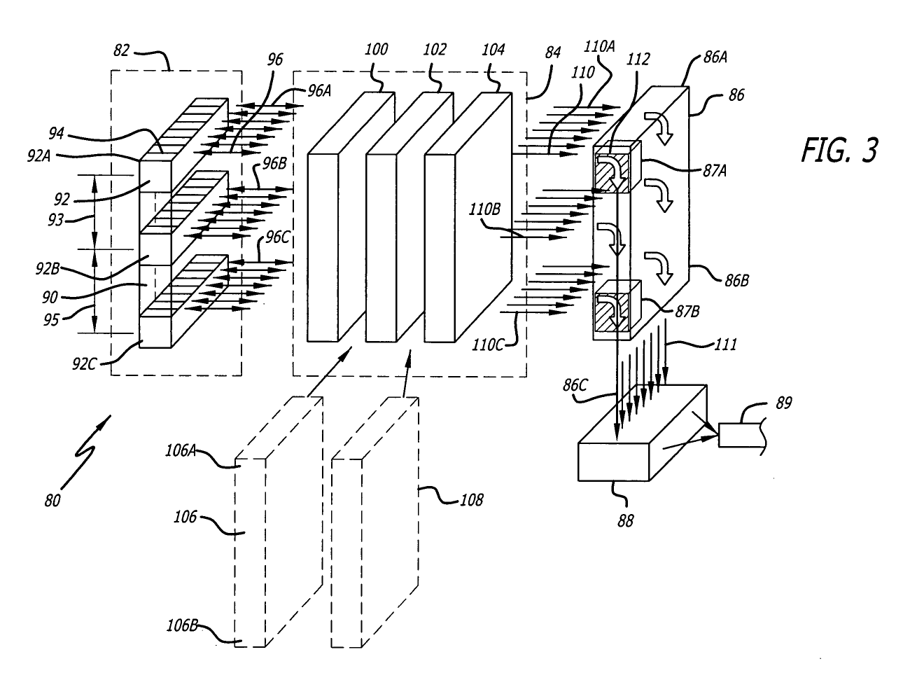

FIG. 3 shows an embodiment of a beam combining apparatus 80. As shown, beam combining apparatus 80 includes a light emitting section 82, beam conditioning section 84 disposed in optical communication with light emitting section 82 and a beam combining device 86 disposed in optical communication with the beam conditioning section 84. The light emitting section 82 includes a light source 90 with at least one light emitting portion 92 which includes one or more light emitters 94. The light emitters 94 are shown emitting one or more beams 96. For the embodiment shown in FIG. 3, the light emitting portion 92 and light emitters 94 thereof, are in the form of laser diode bars. Such diode bars may be operated in either a continuous wave mode or pulsed mode. An emitter 94 of a laser diode bar with optical feedback as discussed above may have an output beam 96 with a peak wavelength positioned to a tolerance of less than about 1 nm and with a spectral width of less than about 1 nm.

In some embodiments, the spectral width of the output beams 96 of the individual emitters 94 of a wavelength locked laser diode bar may be about 0.05 nm to about 1.0 nm. An output beam 96 of all emitters 94 of a laser diode bar which are wavelength locked to the same centroid or peak wavelength with optical feedback may have a total overall spectral bandwidth which may be the same as or similar to that of an individual emitter, or about 0.05 nm to about 1.0 nm. Such laser diode bars may have about 10 to about 65 individual emitters 94 for some embodiments. Such an arrangement produces a high spectral brightness at the peak wavelength of the laser diode bar.

The laser diode bars of the light emitting portion 92 may be stacked at a periodic and regular distribution to produce an array of emitters 94. In the embodiment of FIG. 3, the top laser diode bar 92A is vertically separated from the middle laser diode bar 92B by a separation distance indicated by arrow 93. The middle laser diode bar 92B is separated from the bottom laser diode bar 92C by a distance indicated by arrow 95. For some embodiments, the separation distance indicated by arrows 93 and 95 may be about 1 mm to about 3 mm, specifically, about 1.5 mm to about 2.0 mm. Such a stacked array of laser diode bars 92 and emitters 94 allows more light energy or power to be directed at beam combining device 86 which may produce higher spectral brightness and power output from the beam combining apparatus 80.

Beam conditioning section 84 may include an array of fast axis collimation optics 100, an array of beam shaping optics 102 and array of slow axis collimation optics 104. Beam conditioning section 84 also includes a reflective optic or an array of reflective optics 106 in optical communication with light emitting section 82. Reflective optic 106 may be configured to reflect a pre-selected percentage of each beam 96 in order to provide optical feedback to light emitters 94. The optical feedback may serve to lock or substantially lock the wavelength of one or more emitters 94 at a pre-selected wavelength or pre-selected wavelengths. Wavelength locking may be carried out at wavelengths that are desired for certain wavelength-sensitive applications, such as the pumping of solid state laser materials and the like.

For some embodiments, reflective optic 106 may be a diffractive optic such as a VHG configured to partially reflect beams 96 and narrow the bandwidth of the beams 96. Reflective optic or VHG 106 may, for some embodiments, have the same or similar features, dimensions and materials as those of reflective optic 41 discussed above. As discussed above, a VHG embodiment of the reflective optic 106 may have a non-uniform distribution of refractive index perturbations or response function so as to spatially distribute of the diffractive spectral response of the VHG 106. A chirped VHG is an example of such a diffractive optic embodiment having a peak diffraction wavelength that may vary from top to bottom, side to side or in any other desirable manner.

The beam conditioning section 84 may also include any number of lenses, polarizers, spatial modulators, filters, gratings, or holographic optical elements, and the like. For example, additional optical element 108 may be placed into beam conditioning section 84 in optical communication with one or more beams 96. In one embodiment, optical element 108 may be fixed in place in beam conditioning section 84. In another embodiment, optical element 108 may be movably disposed in beam conditioning section 84.

Beam combining device 86 is disposed in optical communication with an output side of the beam conditioning section 84 and accepts one or more beams 110, which may be spatially distributed and directed to different portions of beam combining device 86. The optical properties of beam combining device 86 reflect, diffract or otherwise redirect the one or more beams 110 into closer spatial proximity and may be redirected to an output axis 86C of beam combining device 86 so as to be spatially overlapped vertically. One or more light beams 112, now redirected by beam combination device 86 enter beam shaping device 88 which is disposed in optical communication with beam combination device 86. Beam shaping device 88 directs one or more light beams 112 into optical device 89. Optical device 89 may be any suitable optical device that is configured to receive light such as waveguide devices, laser rods, gas cells, multiplexers, or polarizers. Exemplary waveguide devices may include an optical fiber or fibers, as well as hollow waveguides and the like. Beam shaping device 88 may include any suitable combination of lenses, filters, mirrors or the like necessary to turn and focus the beams 111 into optical device 89.

In some embodiments, reflective optic 106 may include a volume holographic grating or VHG which is chirped so as to vary the peak diffraction wavelength of the VHG vertically from a top end 106A to a bottom end 106B. In this way, beams 96A emitted from a top laser diode bar 92A will be wavelength locked at a different wavelength than the beams 96B emitted from a middle laser diode bar 92B and bottom laser diode bar 92C. The response function of VHG 106 may be configured to coincide with the response function of the beam combining device or VHG 86.

The response function of VHG 106 and VHG 86 may be configured such that beam or beams 110A entering the top portion 86A of the beam combining device 86 will be at a wavelength that is different from the peak diffraction wavelength of a bottom portion 86B of the beam combining device 86. This allows a beam combining element 87A of the beam combining device 86 to diffract, bend or otherwise redirect beam 112 at a top portion 86A of the beam combining device 86 while allowing diffracted beam 112 emitted from the combining element 87A of the beam combining device 86 to pass through a middle portion and bottom portion 86B of the beam combining device 86 along output axis 86C without significant further diffraction of diffracted beam 112. The configuration of VHGs 106 and 86 may also be such that a beam or beams 96C emitted from bottom laser diode bar 92C, passing through beam conditioning section 84, and entering a bottom portion 86B of beam combining device 86 as beams 110C, will be diffracted or redirected by a beam combining element 87B of the beam combining the device 86. The VHG 106 and beam combining device 86 may be configured such that all beams 110 may be diffracted and spatially overlapped along the output axis 86C, or plane defined by axis 86C, within the beam combining device 86 without substantial further diffraction of the diffracted or redirected beams after being initially redirected. The paths of the redirected or diffracted beams 112 exiting the beam combining elements 87A and 87B of the beam combining device 86 are at an angular orientation of about 85 degrees to about 95 degrees with respect to the path of the beams 110. This angular diffraction which redirects beams 110 to an angle substantially parallel to the output axis 86C is a result of the slant of the periodic function or response function of the beam combining VHG 86. The slant for some embodiments of the beam combining VHG may be about 40 degrees to about 50 degrees, however, other suitable angular slants may be used in order to redirect and overlap the incoming beams 110 through the beam combining VHG along the output axis 86C.

As discussed above, a response function, which may take the form of chirping, or other spatial distribution of a diffractive spectral response due to spatial function of period, depth or contrast of a diffractive optic or VHG of the beam combining device 86 may be mapped or otherwise correspond to the response function of a diffractive reflective optic 106 such that a light ray or beam 96 exiting the reflective optic 106 will have a peak wavelength that matches the peak diffractive wavelength of a portion of the beam combining device 86 which is in the optical path of the same light ray or beam 96. VHGs 16, 41, 86 and 106 may have a response function in the form of chirping so as to have a Bragg phase matching condition or peak diffraction wavelength for a first wavelength at one end and a different peak diffraction wavelength at a second end opposite the first end. Such a response function may be continuously varied (or chirped) across monolithic VHG embodiments 16, 41, 86 and 106 or a portion or portions thereof. However, VHGs 16, 41, 86 and 106 may also be broken down into separate components or sections with each section have a uniform spatial distribution of a diffractive spectral response or response function which is different from response function of adjacent sections of VHGs 16, 41, 86 and 106. A section or component of VHGs 16, 41, 86 and 106 may also have a non-uniform or varied response function. Both the thickness and depth or strength in the form of contrast may affect the response function of VHGs 16, 41, 86 and 106 and may be used to configure VHGs 16, 41, 86 and 106 to provide a desired function.

For some embodiments, beam combining device or VHG 86 may have an interaction length of about 0.1 mm to about 10 mm, a wavelength sensitivity at FWHM of about 0.2 nm to about 15 nm and an angle sensitivity of about 1 mrad to about 5 mrad in plane and about 25 mrad to about 500 mrad out-of-plane. For other embodiments, the beam combining device 86 may have an interaction length of about 0.5 mm, a wavelength sensitivity FWHM of about 1 nm and an angle sensitivity of about 2 mrad in-plane and about 75 mrad out-of-plane.

With regard to the above detailed description, like reference numerals used therein refer to like elements that may have the same or similar dimensions, materials and configurations. While particular forms of embodiments have been illustrated and described, it will be apparent that various modifications can be made without departing from the spirit and scope of the embodiments of the invention. Accordingly, it is not intended that the invention be limited by the forgoing detailed description.

What is claimed is:

1. A beam combining apparatus, comprising:
a light source comprising a first emitter having a first output wavelength and at least one second emitter having a second output wavelength;
a beam conditioning section in optical communication with the light source and configured to collimate the output of the emitters and provide diffractive optical feedback to the emitters; and
a diffractive beam combining device in optical communication with the beam conditioning section and configured to diffract and spatially overlap output beams at the output wavelengths of the first emitter and at least one second emitter.

2. The beam combining apparatus of claim 1 wherein the light source comprises an output wavelength of about 300 nm to about 2000 nm.

3. The beam combining apparatus of claim 1 wherein the beam conditioning section comprises a diffractive optic having a spatial distribution of the diffractive spectral response for providing the optical feedback.

4. The beam combining apparatus of claim 3 wherein the diffractive optic comprises a chirped diffractive optic.

5. The beam combining apparatus of claim 3 wherein the diffractive optic comprises a graded diffractive optic.

6. The beam combining apparatus of claim 3 wherein the diffractive optic comprises a VHG.

7. The beam combining apparatus of claim 1 wherein the diffractive beam combining device comprises a diffractive optic having a spatial distribution of a diffractive spectral response.

8. The beam combining apparatus of claim 7 wherein the diffractive optic comprises a chirped diffractive optic.

9. The beam combining apparatus of claim 7 wherein the diffractive optic comprises a graded diffractive optic.

10. The beam combining apparatus of claim 7 wherein the diffractive optic comprises a VHG.

11. The beam combining apparatus of claim 3 wherein the diffractive beam combining device comprises a spatial distribution of a diffractive spectral response that corresponds to a spatial distribution of a diffractive spectral response of the diffractive optic of the beam conditioning section.

12. A beam combining apparatus, comprising:
a light source comprising a first laser diode bar including a plurality of laser diode emitters having a first output wavelength and at least one additional laser diode bar including a plurality of laser diode emitters having a second output wavelength;
a beam conditioning section in optical communication with the light source and comprising a fast axis collimator and a slow axis collimator configured to collimate the output of the laser diode bars and a VHG configured to provide optical feedback at the first output wavelength to the first laser diode bar and provide optical feedback at the second wavelength to the additional laser diode bar; and
a beam combining VHG in optical communication with the beam conditioning section and configured to diffract an output beam of the first laser diode bar to an output optical axis and diffract an output beam of the additional laser diode bar to the output optical axis so as to spatially overlap the output beams of the first laser diode bar and additional laser diode bar.

13. The beam combining apparatus of claim 12 wherein the VHG of the beam conditioning section comprises a spatial distribution of a diffractive spectral response.

14. The beam combining apparatus of claim 13 wherein the VHG of the beam conditioning section comprises a chirped VHG.

15. The beam combining apparatus of claim 13 wherein the VHG of the beam conditioning section comprises a graded VHG.

16. The beam combining apparatus of claim 13 wherein the VHG of the beam conditioning section comprises a sectioned VHG.

17. The beam combining apparatus of claim 12 wherein the beam combining VHG comprises a spatial distribution of a diffractive spectral response.

18. The beam combining apparatus of claim 17 wherein the beam combining VHG comprises a chirped VHG.

19. The beam combining apparatus of claim 17 wherein the beam combining VHG comprises a graded VHG.

20. The beam combining apparatus of claim 17 wherein beam combining VHG comprises a sectioned VHG.

21. The beam combining apparatus of claim 13 wherein the beam combining VHG comprises a spatial distribution of a diffractive spectral response that corresponds to a spatial distribution of a diffractive spectral response of the VHG of the beam conditioning section.

22. A method of producing an optical beam, comprising
emitting a first output beam from a first wavelength locked emitter;
emitting a second output beam from a second wavelength locked emitter;
diffracting the first and second output beams with a diffractive optical element to an output optical axis in which the first output beam and second output beam are spatially overlapped.

23. The method of claim 22 wherein the first and second output beams are wavelength locked by passing the output beams of the first and second wavelength locked emitters through a reflective VHG.

24. The method of claim 23 wherein the reflective VHG comprises a spatial distribution of a diffractive spectral response

25. The method of claim 24 wherein the reflective VHG comprises a chirped VHG and further comprising passing the first and second output beams through different sections of the chirped VHG such that the first output beam has a different peak wavelength than a peak wavelength of the second output beam.

26. The method of claim 24 wherein the reflective VHG comprises a sectioned VHG having different peak diffraction wavelengths adjacent sections and further comprising passing the first and second output beams through different sections of the sectioned VHG such that the first output beam has a different peak wavelength than a peak wavelength of the second output beam.

27. The method of claim 24 wherein the reflective VHG comprises a graded VHG and further comprising passing the first and second output beams through different sections of the graded VHG such that the first output beam has a different peak wavelength than a peak wavelength of the second output beam.

28. The method of claim 22 wherein the diffractive optical element comprises a beam combining VHG and the first output beam comprises a first peak wavelength and is transmitted to a portion of the beam combining VHG having a peak diffraction wavelength corresponding to the first peak wavelength and second output beam comprises a second peak wavelength different from the first peak wavelength and is transmitted to a portion of the beam combining VHG having a peak diffraction wavelength corresponding to the second peak wavelength and diffracting the first and second beams through the corresponding portions of the beam combining VHG.
